(19) United States
(12) Patent Application Publication
(10) Pub. No.: US 2007/0162657 A1
(43) Pub. Date: Jul. 12, 2007

(54) Method of outputting data onto a copy paper

(76) Inventor: Chia-Chun Chen, Hualien City (TW)

Correspondence Address: HERSHKOVITZ & ASSOCIATES, 2845 DUKE STREET, ALEXANDRIA, VA, 22314, US

(21) Appl. No.: 11/330,335

(22) Filed: Jan. 12, 2006

(51) Int. Cl. G06F 3/00

(52) U.S. Cl. 710/47

(57) ABSTRACT

A method for outputting data onto a copy paper has acts of (a) providing a copy paper having a carrier and an emulsion layer, wherein the emulsion layer with at least one photoactive compound is mounted between the carrier, (b) mirroring an image to a mirror image, inverting color level of the mirror image and outputting the mirror image on a screen of a monitor, (c) putting the copy paper on the screen of the monitor, and (d) exposing the copy paper. Therefore, data can be printed onto a paper without using a printer.

### BACKGROUND OF THE INVENTION

1. Field of the Invention

The present invention relates to a method of printing data onto a paper, and especially to a method of printing data onto a paper without using a printer.

2. Description of the Related Art

With the development of science, computers are more and more popular. To output data, a monitor for showing data off or a printer for printing data on papers is necessary. However, when a user cannot connect the printer to the computer, data cannot be printed on papers. Furthermore, the printer takes a lot of space, needs electrical power, and cannot be carried.

### SUMMARY OF THE INVENTION

The objective of the present invention is to provide a method of outputting data onto a copy paper without using a printer.

In order to achieve the above objective, a method for outputting data onto a copy paper in accordance with the present invention comprises acts of (a) providing a copy paper having a carrier and an emulsion layer, wherein the emulsion layer with at least one photoactive compound is mounted between the carrier, (b) mirroring an image to a mirror image, inverting color level of the mirror image and outputting the mirror image on a screen of a monitor, (c) putting the copy paper on the screen of the monitor, and (d) exposing the copy paper.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional side view of a first embodiment of a copy paper in accordance with the present invention;

FIG. 2 is a cross sectional side view of a second embodiment of a copy paper in accordance with the present invention;

FIG. 3 is a block diagram of a method for outputting data onto a copy paper in accordance with the present invention;

FIG. 4 is a flow chart of a method for outputting data onto a copy paper in accordance with the present invention;

FIG. 5 is a perspective view of a computer applied with the method in FIG. 4 with an initial image on a screen;

FIG. 6 is a perspective view of a computer applied with the method in FIG. 4 with the image reversing and inverting on the screen;

FIG. 7 is an operational perspective view of a computer applied with the method in FIG. 4 with the copy paper sticking on the screen.

### DETAILED DESCRIPTION OF THE PREFERRED EMBODIMENTS

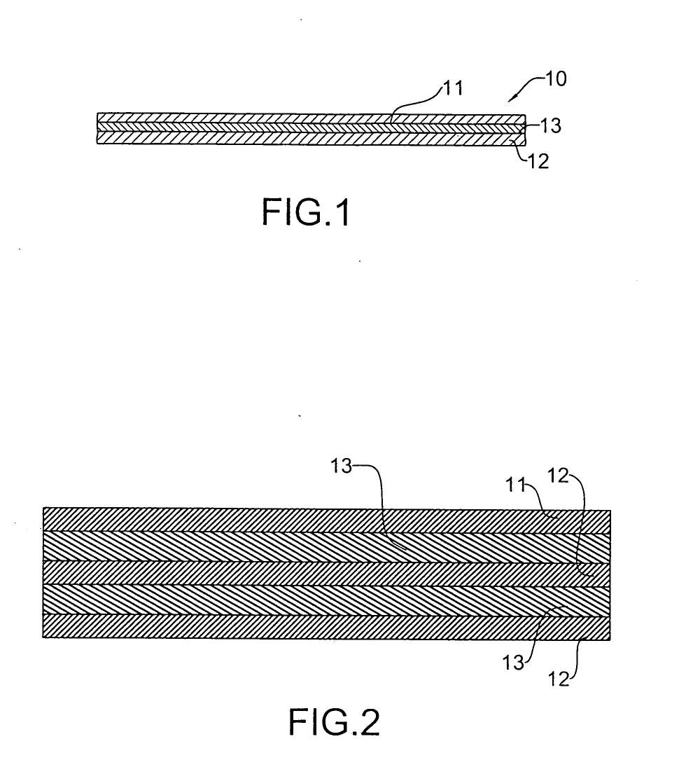

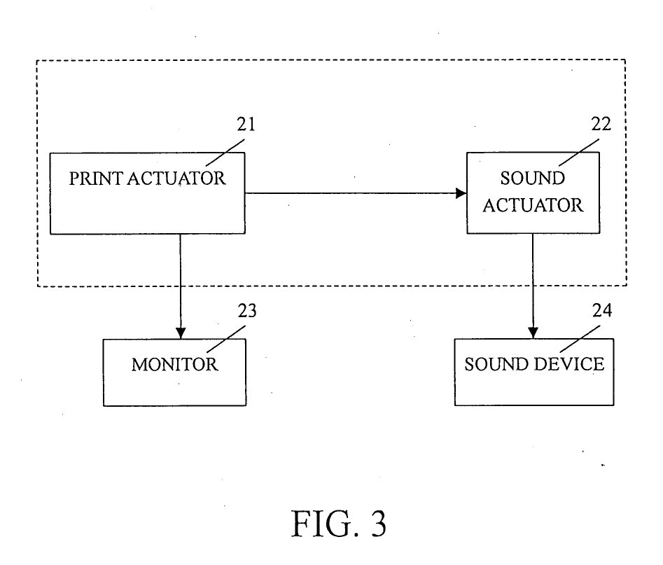

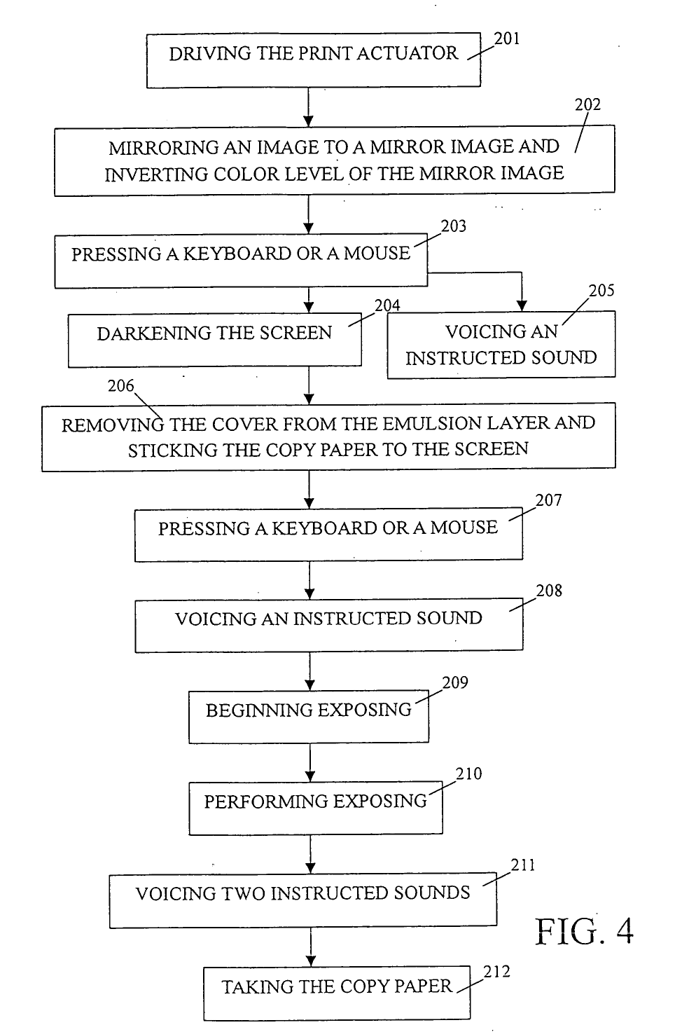

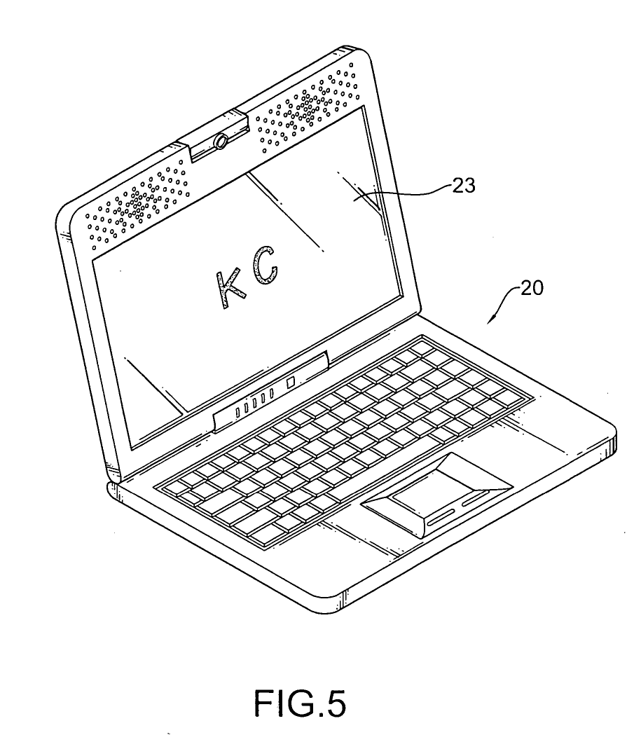

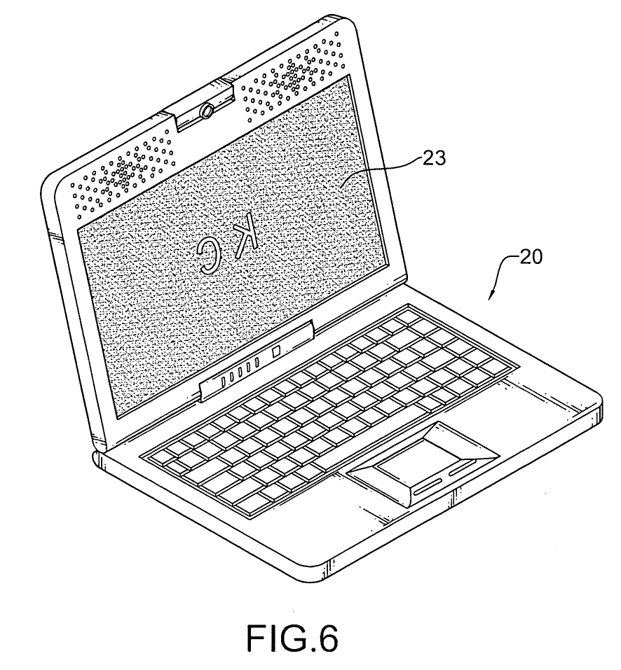

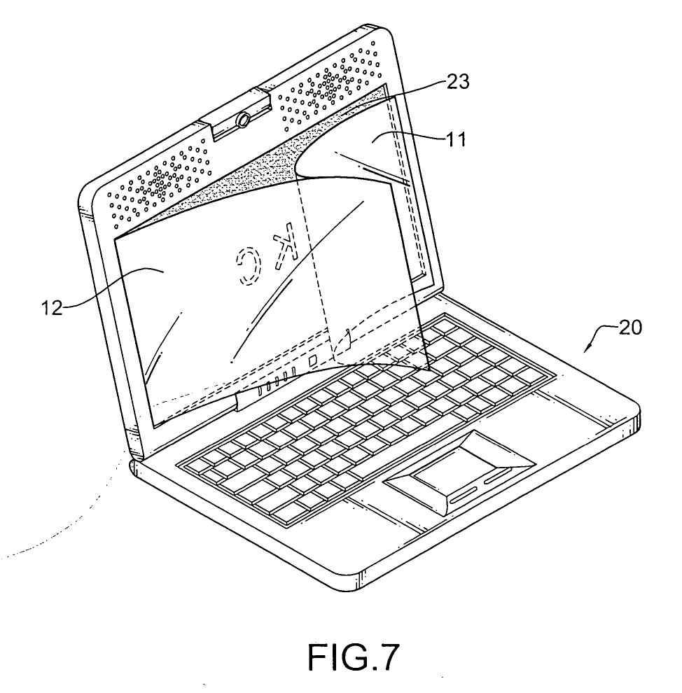

With reference to FIGS. 1 to 7, a method for outputting data by a copy paper in accordance with the present invention comprises acts of:

(a) providing a copy paper (10) having a carrier (12), an emulsion layer (13) and an optional cover (11), wherein the emulsion layer (13) with at least one photoactive compound is mounted between the carrier (12) and the cover (11) is mounted on the emulsion layer (13) to protect the photoactive compound from the light,

(b) mirroring an image to a mirror image, inverting color level of the mirror image and outputting the mirror image on a screen (23) of a monitor (25) of an electronic device, such as a notebook (20),

(c) putting the copy paper (10) on the screen (23) of the monitor (25),and (d) exposing the copy paper (10)

The act of (a) comprises providing a copy paper (10) having a carrier (12), an emulsion layer (13) and an optional cover (11), wherein the emulsion layer (13) with a photoactive compound is mounted between the carrier (12) and the cover (11) is mounted on the emulsion layer (13) to protect the photoactive compound from the light. Preferably, the photoactive compound is silver halides. More preferably, the photoactive compound is selected from the group consisting of AgF, AgCl, AgBr and/or AgI. The speed of the sensitization of AgBr is the fastest and AgCl is the slowest. The emulsion layer (13) and/or the carrier (12) further comprise a paste to stick on the screen (23) of the monitor. In addition, the copy paper (10) may have multiple emulsion layers (13) and multiple carriers (12) stacked in sequence.

The act of (b) comprises mirroring an image to a mirror image, inverting color level of the mirror image and outputting the mirror image on the screen (23) of the monitor (25). Preferably, a print actuator (21) deals with the action of mirroring of an image to a mirror image and inverting color level of the mirror image. The print actuator (21) further comprises a function of setting exposed time and hues. The print actuator (21) is driven by a keyboard or a mouse to begin the exposing action. More preferably, the print actuator (21) connects with a sound actuator (22) and the sound actuator (22) can drive a sound device (24) on. When the beginning or the end of the exposure action or the screen (23) of the monitor (25) being turning to a dark screen, the sound actuator (22) drives the sound device (24) to generate sound and provide a warning effect.

Before the act of (c), the print actuator (21) drives the screen (23) of the monitor (25) to a dark screen so the copy paper cannot be exposed unintentionally.

The act of (c) is putting the copy paper (10) onto the screen (23). The act of (d) comprises exposing the copy paper (10). A user exposes the emulsion layer (13) with the photoactive compound to light from the screen (23).

After driving the print actuator (201), the image is mirrored and inverted (202). When a user presses a keyboard or a mouse (203), the screen (23) darkens (204) and the sound device to voice an instructed sound (205). The user removes the cover (11) from the emulsion layer (13) and sticks the copy paper (10) onto the screen (206). Then the user presses a keyboard or a mouse again (207) to begin the exposing action (209) and the sound device keeps generating the instructed sound (208). After performing exposing (210), the sound device (24) voices two instructed sounds (211). Then the user takes the copy paper (10) (212) from the screen (23). Therefore, data can output onto the copy paper (10) (212) by the method in accordance with the present invention without using a printer.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method for outputting data onto a copy paper comprising
(a) providing a copy paper having a carrier and an emulsion layer, and wherein the emulsion layer with at least one photoactive compound is mounted on the carrier;
(b) mirroring an image to a mirror image, inverting color level of the mirror image and outputting the mirror image on a screen of a monitor;
(c) putting the copy paper on the screen of the monitor; and
(d) exposing the copy paper.

2. The method as claimed in claim 1, wherein the acts of mirroring image action to a mirror image and inverting color level of the mirror image is acted by a print actuator.

3. The method as claimed in claim 2 further comprising an act of generating a instructed sound generated by a sound device connected to the print actuator.

4. The method as claimed in claim 2, wherein before the act of putting the copy paper on the screen of the monitor, the screen is turned to a dark screen to keep the copy paper from being exposed unintentionally.

5. The method as claimed in claim 3 further comprising an act of generating an instructed sound by the sound device when beginning or end of the acts of exposing the copy paper.

6. The method as claimed in claim 4 further comprising an act of generating an instructed sound by a sound device when the screen is turned into the dark screen.

7. The method as claimed claim 1, wherein the photoactive compound is silver halides.

8. The method as claimed claim 7, wherein the photoactive compound is selected from one of the group consisting of AgF, AgCl, AgBr and AgI.
